(19) United States
(12) Patent Application Publication
(10) Pub. No.: US 2012/0067041 A1
(43) Pub. Date: Mar. 22, 2012

(54) Heat Engine

(75) Inventor: Philippe Verplancke, Ottobrunn (DE)

(73) Assignees: Philippe Verplancke, Ottobrunn (DE); Christian Unterreitmeier, Bad Endorf (DE)

(21) Appl. No.: 13/264,950

(22) PCT Filed: Apr. 15, 2010
(86) PCT No.: PCT/DE2010/000427

§ 371 Date: Nov. 23, 2011

(30) Foreign Application Priority Data
Apr. 16, 2009 (DE) 10 2009 017 493.1

(51) Int. Cl. F02G 1/043

(52) U.S. Cl. 60/517

(57) ABSTRACT

A heat engine comprises a first displacing piston and a second displacing piston, wherein a surface of the first displacing piston and a surface of the second displacing piston that face each other limit a working space that is filled with a working gas. The two heat exchanger arrangements are arranged in the working space between the first displacing piston and the second displacing piston, each heat exchanger arrangement comprising a heat source and a heat sink. The working gas flows through or circulates around each of the two heat exchanger arrangements. The first displacing piston, and the second displacing piston, and/or the heat exchanger arrangements are rotatably mounted with respect to an axis. Measures are provided for counteracting against a circular motion of the working gas around the axis relative to the heat exchanger arrangements.

### BACKGROUND AND SUMMARY OF THE INVENTION

The present invention relates to a thermal or heat engine.

It is known that heat engines using a closed gas cycle and being operated at small temperature differences between heat source and heat sink need large heat exchanger surfaces to transfer the necessary heat (see for example DE 41 09 289 A1 or EP 0 801 219 B1). Furthermore, heat engines are known, wherein the working gas flows through heat exchangers and, where appropriate, regenerators that have a high heat exchanger density (see for example the original Stoddard engine from 1933 (U.S. Pat. No. 1,926,463 A) or the more modern machines from Stirling Biopower Inc.). DE 43 07 211 A1 shows a design, wherein the working gas is moved by a continuously rotating displacement piston from the warm side to the cold side of the working space during the first half of a period and is rotated further from the cold side to the warm side during the second half of the period.

U.S. Pat. No. 3,509,718 A describes a heat engine having two housings that are formed epitrochodially. Displacing pistons that have, front faces and three-sided surfaces rotate in each of the housings on an eccentric shaft, wherein the working gas is moved between working spaces that are provided between the housing parts and the displacing pistons. However, due to different pressure levels in the different working spaces, seals are subject to extensive wear.

EP 0 691 467 A1 shows a hot gas engine having a displacing piston that is movable within a closed housing. The displacing piston rotates around a working piston that is mounted axially movably within the displacing piston. Due to the construction the design is very complex, in particular if large working space volumes are involved.

Low heat transmission, hence, low mechanical output power that can be achieved at ideal rotating speed, remains as a problem related to heat engines with large heat exchange surfaces. Heat engines that have a working gas flowing through one or more heat exchangers have the problem that a large flow rate of the working gas is necessary to achieve appreciable mechanical output powers at low temperature differences between heat source and heat sink. Furthermore, the known designs generate large flow losses. The design known from DE 43 07 211 A1 having a rotating displacing piston has the problem of the low heat transfer due to the cylindrical housing wall as well as the problem of the low efficiency factor, because the heat cannot be recycled or can only be recycled minimally with this design.

It is the object of the invention to provide a heat engine that has a considerable higher mechanical output power in relation to the volume of the machine, at lower temperature differences between the heat source and the heat sink, as well as smaller flow losses, that is, a heat engine providing a higher efficiency factor than the known designs.

The heat engine according to the present invention comprises a first displacing piston and a second displacing piston, wherein a surface of the first displacing piston and a surface of the second displacing piston that face each other limit the working space that is filled with a working gas. Two heat exchanger arrangements are arranged in the working space between the first displacing piston and the second displacing piston, each heat exchanger arrangement comprising a heat source and a heat sink. The working gas flows through or circulates around each of the two heat exchanger arrangements. The first displacing piston, the second displacing piston, and/or the heat exchanger arrangements are rotatably mounted with respect to an axis. Measures are provided for counteracting against a circular motion of the working gas around the axis relative to the heat exchanger arrangements. In this way, the working gas, for example air, can be moved from a region of the working space to another region of the same working space during one work cycle, wherein a first part of the working gas flows through one of the heat exchanger arrangements, and wherein the second part of the working gas flows through a second heat exchanger arrangement, and wherein both parts of the working gas release or absorb energy that can be converted to mechanical work. It may be provided that the displacing pistons rotate synchronously, that is, they rotate in the same rotating direction. However, it is also possible that the displacing pistons rotate in opposite rotating directions or that only one or none of the two displacement pistons rotates. Changing the rotating direction and the rotating speed of the displacing pistons has an effect on the circulation of the working gas about the axis, hence, the efficiency factor. In particular, the axis can be an axial axis.

It is usefully provided for that the surface of the first displacing piston that limits the working space is curved convexly, wherein the surface of the second displacing piston that limits the working space is curved concavely. In this way, the working gas is moved inwardly or outwardly in radial direction with respect to the rotation axis of the displacing piston. In particular, the rotation axis of the displacing pistons can be an axial axis.

Advantageously, it is provided that the surface of the first displacing piston and the surface of the second displacing piston that limit the working space are surfaces of cylinder barrels substantially, wherein the symmetry axes of the cylinders do not coincide with the axis. Such surfaces can be produced very easily, such that the design of the complete heat engine becomes very simple.

Additionally, it is provided for that the first displacing piston and the second displacing piston execute a rotating motion with identical frequencies within a housing, wherein a housing wall in combination with the surface of the first displacing piston and the surface of the second displacing piston that face each other limit the working space. The surfaces of the first displacing piston and the second displacing piston, respectively, that limit the working space have convex and concave areas, wherein the convex areas of the first displacing piston correspond to or face the concave areas of the second displacing piston, wherein the concave areas of the first displacing piston correspond to or face the convex areas of the second displacing piston. The spatial arrangement and the number of convex and concave areas of the first displacing piston and second displacing piston correspond to the spatial arrangement and the number of the heat exchanger arrangements. A heat source corresponding to each convex area of a displacing piston exists that faces this displacing piston. A heat sink corresponding to each concave area of the same displacing piston exists that faces this displacing piston. In this way, a motion of the working gas is parallelly induced to the rotating axis of the displacing pistons during one work cycle. In particular, the rotating axis of the displacing piston can be an axial axis. A rotating motion of identical frequencies does not exclude that the frequencies vary in time.

Additionally, it is provided for that the first displacing piston and the second displacing piston are produced in one piece. Thus, the first displacing piston and the second displacing piston are coupled rigidly, such that only a single mechanism is necessary to move the displacing pistons.

Additionally, it is provided for that the heat exchanger arrangements comprise a regenerator. In this way, the total efficiency of the heat engine is increased.

It can furthermore be provided for that the means for counteracting a circular motion of the working gas with respect to the axis comprise a blower or a fan. The circular motion of the working gas can be at least damped with a working gas stream that points to the opposite direction by using a blower or a fan that counteracts against the circular motion of the working gas that is induced by the displacing pistons.

It is usefully provided for that the means for counteracting against a circular motion of the working gas around the axis comprise a panel that is movable in a reciprocating fashion in a plane transverse to the displacing pistons or transverse to the heat exchanger arrangements. In this way, an obstacle that brakes the circular motion of the working gas can be positioned in the working space. Advantageously, the obstacle seals a cross section of the working space that is as large as possible.

Advantageously, it is provided for that the means for counteracting against a circular motion of the working gas around the axis comprise a panel that rotates around a mounting axis. Also in this way, an obstacle that brakes the circular motion of the working gas can be positioned in the working space.

In this connection, it can be provided that the means for counteracting against a circular motion of the working gas around the axis comprise a further panel that rotates with respect to the panel in the opposite direction around the mounting axis. In this way, the braking efficiency can be improved because the obstacle seals a larger cross section of the working space in the unwanted direction of flow.

Furthermore, it can be provided for that the means for counteracting against a circular motion of the working gas around the axis comprise the heat exchanger arrangements that rotate around the axis synchronically with the working gas. The rotation of the one or more displacing pistons induces the circular motion of the working gas around the axis due to “coupled motion effects”. In particular, this induced circulation depends on the shape of the surfaces of the displacing pistons, the shape of the working space, as well as the rotating speeds of the displacing pistons. During operation, the induced circulation will level out at a fixed value or a fixed chronological sequence. It is possible to determine the value or the sequence and to move the heat exchanger arrangements around the axis accordingly. In this way, the circulation of the working gas around the axis with respect to the heat exchanger arrangements can be compensated. The determination of the value or the sequence can be done in advance theoretically or experimentally. However, it is also possible to determine the rotation speed of the working gas by a sensor arranged in the working space and to control a rotation of the heat exchanger arrangements accordingly.

It can be provided for that the first displacing piston and the second displacing piston are completely arranged in the housing, wherein a gas-filled gap is provided between the borders of the first and/or second displacing piston and the housing, and between the back sides of the first and/or second displacing piston and the housing, and wherein the gas-filled gap provides a pressure equalization between the working space and the back sides of the first and/or second displacing piston. This allows a light-weight construction of the displacing pistons that is because the displacing pistons are only loaded by the dynamic pressure of the air volumes that have to be displaced.

Furthermore, it can be provided for that the heat engine comprises a further working space that is limited by the second displacing piston and a third displacing piston, wherein the working space and the further working space are orientated back to back such that the back side of the second displacing piston forms a surface that limits the further working space, and wherein the third displacing piston and/or heat exchanger arrangements that are arranged in the further working space are rotatably mounted with respect to the axis. The output power of the heat engine can be increased by providing a further working space.

It is usefully provided for that a gas exchange is possible between the working space and the further working space, and wherein the heat exchanger arrangements are arranged, such that the working space works in a heat engine mode and the further working space works in a heat pump mode when the displacing pistons rotate synchronically.

In particular, it can be provided for that the working space and the further working space have different sizes.

The described heat engine provides mechanical output power while it absorbs heat from a heat source and dispenses heat to a heat sink on a lower temperature level. Advantageously, the engine may comprise at least two heat exchanger arrangements, wherein a working gas flows through or circulates around the heat exchanger arrangements. Each of the heat exchanger arrangements may comprise a heat source, a heat sink, and, where appropriate, a regenerator. In the following, such an arrangement of a heat source and a heat sink is referred to as a heat exchanger arrangement, whether or not a regenerator is present.

The described heat engine reciprocates the working gas through the heat exchanger arrangements from the warm side of the engine to the cold side of the engine by one or more displacing pistons. The described heat engine may use two displacing pistons that do not perform a stroke movement but a rotating motion of exactly identical frequencies.

The working space that contains the working gas is limited by the stationary housing wall and the rotating surfaces of the displacing pistons. In one embodiment of the heat engine, the housing is shaped as a cylinder having a recess around the axis, wherein the displacing pistons complete the faces of the cylinder. The rotation of the displacing piston takes place in an azimuthal direction around an axis that may be particularly an axial axis.

Advantageously, the surfaces of the displacing pistons may have a number of convex and the same number of concave areas, wherein the concave and the convex areas face convex and concave areas of the other displacing piston, respectively. The working gas is inhibited from performing a coupled motion with the rotating displacing piston by an appropriate braking apparatus. Thus, the working gas does not perform a circulation around the axis or does only execute a slow circulation around the axis as compared with the displacing pistons. The part of the working gas that is passed by the rotation of a convex region of the surface of the first displacing piston is displaced in direction of the concave region of the surface of the opposite second displacing piston. The heat exchanger arrangements are arranged stationary in the space between the two displacing pistons. The part of the working gas mentioned above flows through a heat exchanger arrangement due to the described displacement. At the same time, another part of the working gas is moved from a convex area of the second displacing piston that passed the concave area of the first displacing piston by rotation, thus it is moved in the opposite direction through another heat exchanger arrangement. The heat exchanger arrangements named first and last are embedded into the engine with opposite orientations with respect to the heat sources and heat sinks, such that both parts of the working gas are heated simultaneously. Depending on the number of convex areas of each displacing piston, this embodiment includes the corresponding number of pairs of heat exchanger arrangements. When a concave area of the first displacing piston passes the part of the working gas that was named first by rotation, the process reverses and all parts of the working gas that have been heated before are cooled simultaneously. In other words: the working gas is moved by a convex or concave area of the surface of a displacing piston to the corresponding concave or convex area of the surface of the opposite displacing piston, respectively. In doing so, the working gas flows through or circulates around a heat exchanger arrangement that comprises a heat source, an optional regenerator, and a heat sink in this or in the opposite direction, wherein the shape and the arrangement of the heat exchanger arrangements are adjusted to the shape and arrangement of the convex and concave areas of the displacing pistons, such that the working space is almost completely on the side of the heat sources during defined periods during rotation of the displacement device, and is almost completely on the side of the heat sinks during other periods, wherein at least one working piston increases the working space during the period when the working gas is heated or is almost completely on the warm side, and decreases during the period when the working gas is cooled or is almost completely on the cold side.

The above description is valid if the heating or the cooling takes place first. Furthermore, it can be provided for that the heat sources, the regenerators and the heat sinks have a flat configuration and that they are arranged almost perpendicular to the direction of the reciprocating motion of the working gas with a small intermediate distance, and that the total thickness of the heat exchanger arrangements that comprise a heat source, a regenerator and a heat sink is small in relation to the distance between the two surfaces of the displacing pistons. Advantageously, the total thickness of a heat exchanger arrangement is between 5% and 15% of the distance between the two surfaces of the displacing pistons.

In the described heat engine, the working gas flows through heat source and heat sink during the same work cycle of the gas cycle. Thus, it is advantageous to arrange a regenerator between heat source and heat sink to reduce direct heat loss that does not contribute to the generation of mechanical energy from the heat source to the heat sink. The regenerator makes sure that cold gas does not come into direct contact with the heat source. Due to the large-scale design, the regenerator only generates a small flow resistance in the heat engine according to the present invention, and the regenerator can optimally fulfill its role of regeneration of heat. Thus, heat is taken from heat source near the high temperature level, and heat is given to the heat sink near the low temperature level. Accordingly, the machine has a good efficiency factor.

In connection with the present invention, the term working piston may denote everything that is appropriate to change the volume of the working space, for example, a membrane, a bellows that may be closed at one side, a liquid column, or a gas column.

The described heat engine may have at least one working piston that increases the volume of the working space mainly in the period in which the working gas is heated or is almost completely on the warm side, and that decreases the volume of the working space mainly in the period in which the working gas is cooled or is almost completely on the cold side. Depending on the period in which the change of the volume exactly occurs, the heat engine works with isochore heat exchange processes and adiabatic compression processes or expansion processes in an extreme case, or else with an expansion that occurs mainly when heat is added and a compression that occurs mainly when heat is dissipated. According to the phase shift between the displacement devices and the working piston that is constructive by induced or related to the control technique and according to the stroke of the working piston, the described heat engine can target specific parameters, for example, a maximal generation of mechanical energy per rotation or a maximal pressure amplitude or any other property known to a person skilled in the art.

In a preferred embodiment of the described heat engine, the motion of the working piston takes place in a connecting piece that is associated with the housing and that is connected with the working space. The displacing pistons may have a piston skirt that prevents the leaking of working gas from the housing when a convex area of the displacing piston rotatingly passes the connecting piece of the working piston.

An advantageous further embodiment of the described heat engine comprises at least two working pistons. One working piston increases the volume of the working space mainly in a period in which the working gas is almost completely on the warm side. The second working piston increases the volume of the working space mainly in the period in which the working gas is heated. Thus, the shape of the thermodynamical gas cycle is changed.

In an advantageous further embodiment, a heat exchanger embodiment can be mounted with the heat source facing to the connecting piece at the junction between the housing and the connecting piece of the last mentioned working piston. Advantageously, the junction between the housing and the connecting piece can be constructed, such that only working gas can flow from the cold region of the housing into the connecting piece. This can be achieved, for example, with a cover plate. Thus, the efficiency factor of the engine can be further influenced positively. With reference to the almost ideal thermo dynamical processes that take place, a working piston of the first mentioned type can be described as a adiabatically working piston, and a working piston of the last named type can be described as an isobaric working piston.

The use of an isobaric working piston causes the gas that is compressed by the adiabatic working piston to be not compressed further during the heating period. Thus, it is avoided that the working gas reaches the heat sink with an increased temperature that is far too high. Consequently, the efficiency factor of the engine is increased.

In an advantageous further embodiment of the described heat engine, the working piston is rigidly coupled to a piston rod. The piston rod performs a swiveling motion around a swiveling axis. This swiveling axis absorbs the transverse forces that act on the connecting rod, such that the working piston only has to absorb the pressure forces of the working gas and its own inertial forces. Thus, the working piston can be favorably designed as a thin plate that, for example, can be curved to decrease a clearance volume in the connecting piece.

The volume that is influenced by an adiabatic working piston cannot be completely included in the heating process and the cooling process by the displacing piston due to the design of the described heat engine. The volume that is not included in the heating process and the cooling process forms a clearance volume or dead space and reduces the achievable efficiency factor of the engine. Therefore, this engine has a good efficiency factor, especially in case of a low expansion or compression factor. The design related clearance volume of this heat engine that is optimized for operation with low temperature differences does not produce a big disadvantage, because a low compression factor is used with a gas cycle having low temperature differences between heat source and heat sink. The heat exchanger arrangements through which the working gas flows form a second clearance volume. Thus, in an advantageous further embodiment of the present heat engine, the heat exchanger arrangements are designed as flat as possible with a thin structural shape compared to the width of the working space. The heat source, the regenerator and the heat sink of the heat exchanger arrangement are flat and arranged in parallel to each other with an intermediate distance that is as small as possible. Preferably, heat sources and heat sinks are designed as liquid to gas heat exchangers, for example, as fin heat exchangers, and the regenerator is designed as a gas to solid heat exchanger. The heat exchanger arrangement can be formed, such that they generate only a low flow resistance for the working gas because they provide a large cross section surface due to the design of the heat engine according to the present invention.

A third clearance volume is formed by the parts of the working gas that are in front of a convex area of the displacing piston, but do not flow through the corresponding heat exchanger arrangement. In the preferred embodiment of the heat engine according to the present invention, the convex and concave areas of the displacing pistons together have a shape that resembles a sinusoidal wave, wherein this kind of clearance volume is small. The clearance volume may be further reduced by flattening the heights and depths of the sinusoidal wave. However, in this case the transition between the convex and the concave areas becomes very sharp. Thus, it is possibly more difficult to avoid that the working gas partially rotates together with the displacing pistons.

Appropriate seals that correspond to the state of the art may be mounted between the working piston and the connecting piece, or between the rotating displacing pistons and the wall housing, or between the piston skirt of the displacing pistons and the wall housing. However, according to an advantageous further embodiment of the invention, these seals can be omitted at least partially, that is, a small gap is provided instead of an omitted seal. According to low compression factors that are mentioned above, the loss of mechanical output power is small due to the insignificant amount of working gas that leaks through the gap. The average value of the gas pressure in the engine circuit is almost identical with the surrounding pressure level if gap seals are used.

In a further embodiment the displacing pistons and their rotating axes can be constructed especially light and built cheap because the displacing pistons that have a relative large surface are not exposed to a single-sided pressure load.

The rotation frequency of the displacing pistons can be chosen lower at a steady output power by using two or more working spaces. In this way, the flow losses that are related to the design of the engine can be reduced.

In another advantageous further embodiment of the described heat engine that prevents the working gas from circulating together with the displacing pistons, the braking apparatus may comprise one or more blowers or fans that can be mounted, for example, at the external periphery of the cylindrical housing, and that can be connected to the housing, for example, via tangential pipe couplings. These blowers or fans accelerate the working gas through the housing in the direction opposite to the rotation of the displacing piston. Also, it is possible to mount a propeller at a displacement device, and to let the propeller rotate together with this displacement device.

In another advantageous further embodiment of the described heat engine, the braking apparatus that prevents the working gas from rotating together with the displacing pistons comprises at least a panel that is reciprocated or rotated in a plane transverse to the displacing pistons or transverse to the heat exchanger arrangements. The panel is shaped, and its rotating motion or reciprocating is designed, such that it seals an area of the cross section of the working space in the unwanted direction of rotation that is as large as possible without contacting the displacing pistons at any time. In a further embodiment, two rotating panels that rotate in opposite directions are used. In this way, a larger area of the cross section of the working space can be sealed in the time average. Only a very low mechanical power for the driving mechanism of the panel has to be provided because the panels are orientated perpendicular to the rotating motion of the displacing pistons or the gas stream that has to be braked.

It is known, how the output power generated by the working piston can be used economically, for example, by a generator for the generation of electricity. Furthermore, many possibilities are known to use a small part of the output power of the working piston to drive the rotating motion of the displacing pistons continuously. This driving power needs to compensate only the small flow losses of the working gas generated by the relative motion between displacing piston and working gas.

It is also known that a heat engine having a closed gas cycle can operate as a heat pump when absorbing mechanical power in a reverse operation mode (i.e. in the opposite direction of rotation). Therefore, the use of the described heat engine as a heat pump is not described in greater detail, and in particular the term heat engine covers the term heat pump. However, claims 14 and 15 describe special combinations of working spaces that are connected with each other whereby Vuilleumier heat pumps are generated, wherein the working piston is omitted, and wherein only a minimal mechanical power is necessary to drive the displacing piston.

### BRIEF DESCRIPTION OF THE DRAWINGS

By way of example a preferred embodiment of the present invention will now be described in detail with reference to the drawings in which:

FIG. 1 is a sectional view through a first embodiment of a heat engine perpendicular to an axis;

FIG. 2 is a sectional view through a second embodiment of a heat engine perpendicular to an axis;

FIG. 3 is a sectional drawing through a housing, displacing pistons, heat exchanger arrangements, and a working piston;

FIG. 4 is an example of a perspective drawing of the shape of a displacing piston;

FIG. 5 is a sectional drawing through the area of the heat exchanger arrangements of an embodiment having one working piston;

FIG. 6 is a sectional drawing through the area of the heat exchanger arrangements of an embodiment having two working pistons;

FIGS. 7, 8, 9 are schematic representations of convex and concave areas of displacing pistons and of the heat exchanger arrangements at different times;

FIG. 10 is a detailed view of a working piston, a crankshaft, a connecting rod and a piston rod;

FIGS. 11, 12 show two braking panels at different times;

FIG. 13 shows two rotating braking panels in the view of FIG. 7;

FIG. 14 shows a further embodiment of a heat engine;

FIG. 15 shows a further embodiment of a heat engine;

FIG. 16 shows a further embodiment of a heat engine.

In the following, same reference signs refer to identical or similar parts.

### DETAILED DESCRIPTION OF THE DRAWINGS

FIG. 1 is a sectional view through a first embodiment of a heat engine perpendicular to an axis. In this and all following figures the axis 36 can be, for example, an axial axis. The axis 36 is oriented perpendicularly to the shown section plane. A first displacing piston 12 and a second displacing piston 14 are rotatably mounted with respect to the axis 36. The surface 16 of the first displacing piston 12 and the surface 18 of the second displacing piston 16 that are facing each other limit a working space 22 in a radial direction with respect to the axis 36. The working space 22 forms a continuous one-piece volume, such that pressure gradients within the working space 22 are not generated or generated pressure differences are reduced quickly.

In the following, an area or a region of an area can be referred to as convex if any two points on the surface or on the region of the area can be connected to each other via a straight line that does not extend into the working space limited by the surface or the region of the area. In contrast, a surface or a region of an area can be referred to, for example, as concave, i.e. not convex, if not all points on the surface or on the region of the area can be connected pairwise by a straight line that does not extend into the working space limited by the surface or the region of the area. Thus, the surface 16 is convex and the surface 18 is concave. However, the terms convex and concave are also used if the named conditions are fulfilled substantially, for example, except for joints, interfaces, and due to production-related accuracies or inaccuracies.

Two heat exchanger arrangements 24, 26 are arranged between the working space 22 stationary. Together, the two heat exchanger arrangements 24, 26 form a substantially concentric circular ring with respect to the axis 36. As usually, the heat exchanger arrangements 24, 26 comprise, in radial direction, a heat source and a heat sink, wherein a regenerator may be optionally arranged between the heat source and the heat sink. The radial sequence of heat source and heat sink of the heat exchanger arrangement 26 is inverted with respect to the heat exchanger arrangement 24. Each heat exchanger arrangement 24, 26 range over 180° in the direction of the polar angle with respect to the axis 36. Furthermore, the described heat engine 10 comprises a housing 38 that envelops the second displacing piston 14. The housing 38 can complete the working space 22 at one or both ends of the displacing pistons 12, 14. Therefore, the housing 38 can limit one or both face sides of the working space 22 that has a cylindrical shape with a circular ring-shaped base area.

It is also possible that the first displacing piston 12 and the second displacing piston 14 are produced in one piece and that they seal one of the face sides of the working space 22. An working piston (not shown) can be arranged at the face side of the working space 22. Output power can be taken from the heat engine 10 via the working piston. The heat exchanger arrangements 24, 26 can generate temperature gradients via connecting pieces that are not visible in this cross section. Furthermore, the first displacing piston 12 and the second displacing piston 14 are driven synchronously around the axis 36 in fashion that is not illustrated. A panel 52 that is reciprocating in radial direction between the first displacing piston 12 and the second displacing piston 14, and that brakes a circular motion around the axis 36 of the working gas, wherein the working gas that is present within the working space 22, is illustrated within the working space 22. The panel 52 can be moved with the first displacing piston 12 and the second displacing piston 14 synchronously without touching the displacing pistons 12, 14, for example, via a mechanism that is not visible, and that is arranged at a face side of the working space 22.

Alternatively, it is for example possible that the panel 52 is seated by rolling beads between the first displacing piston 12 and the second displacing piston 14 and that the panel 52 is reciprocatingly moved within the working space 22 in radial direction during the rotating motion of the displacing pistons 12, 14. In the illustrated first embodiment, the working space 22 is cylindrically shaped with a circular ring-shaped base area, and the surfaces 16, 18 that limit the working space 22 are substantially cylinder barrels that eccentrically rotate around the axis 36. The rotation of the displacing pistons 12, 14 can take place in the same direction of rotation or in the opposite direction of rotation. The rotation can take place with identical or different rotating speeds that may vary in time. In this way, the rotation of the working gas around the axis 36 can be influenced. In particular, it is thus possible that the means for counteracting against a circular motion of the working gas around the axis 36 relative to the heat exchanger arrangements 24, 26 comprise the displacing pistons 12, 14 that rotate in the opposite direction around the axis 36. The circulation of the working gas with respect to the heat exchanger arrangements 24, 26 can be counteracted against by a rotation of the heat exchanger arrangement 24, 26 if the heat exchanger arrangements 24, 26 are rotatably mounted with respect to the axis 36. It is even possible to fix the displacing pistons 12, 14 if the panel 52 rotates together with the heat exchanger arrangements 24, 26. Approximately, this corresponds to a cinematic reversal.

The statements that have been made in connection with FIG. 1 and that are related to the rotating directions and the rotating speeds of the displacing pistons 12, 14 and of the heat exchanger arrangements 24, 26 can be transferred to the other embodiments analogously, even if they are not mentioned explicitly.

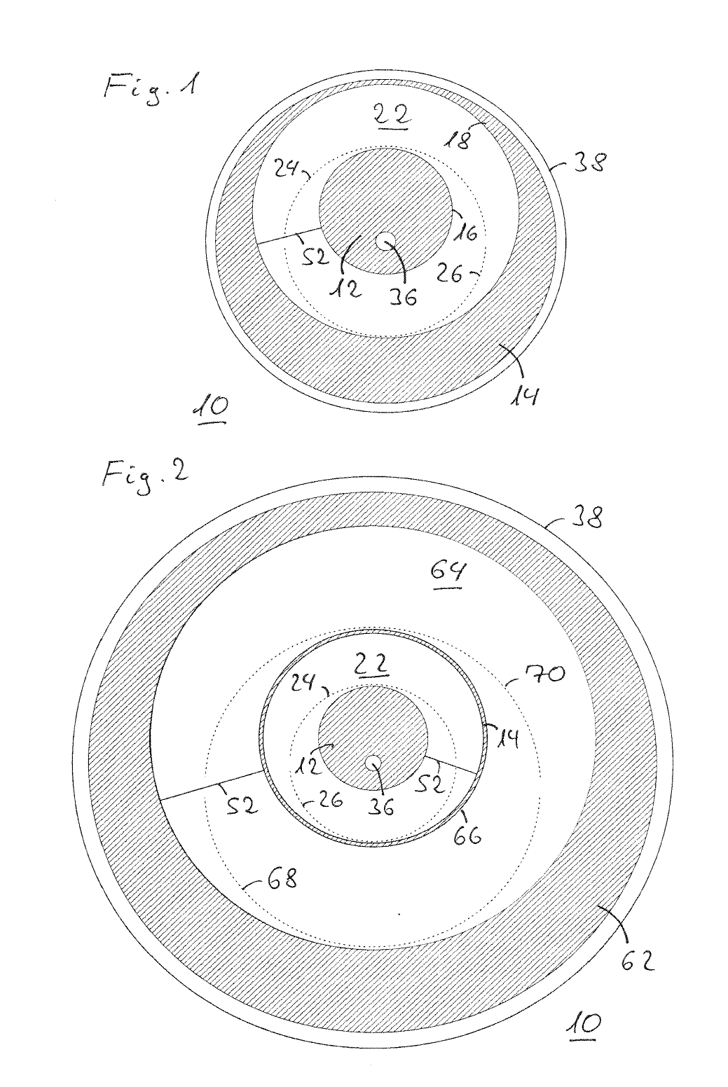

FIG. 2 is a sectional view through a second embodiment of the heat engine perpendicular to an axis. In the described second embodiment of the heat engine 10, a third displacing piston 26 is arranged in radial direction outside of the second displacing piston 14, such that between the second displacing piston 14 and the third displacing piston 26 a further working space 64 is generated. Further heat exchanger arrangements 68, 70 are arranged in the further working space 64 stationary. The further working space 64 is a continuous one-piece volume, too. Furthermore, a panel 52 is pictured in the further working space 64. The panel 52 brakes a circular motion of the working gas present in the further working space 64. The circular motion can take place with respect to the axis 36. In particular, the axis 36 can be an axial axis. The second displacing piston 14 shows a convex surface 66 on its outer face limiting the further working space 64 inwards in the radial direction. The working space 22 and the further working space 64 may communicate with each other, for example, via a connection in the region of the face sides of the heat engine, that is, at the ends of the displacing pistons 12, 14, 62. Other components described in FIG. 2 correspond to components already known from FIG. 1.

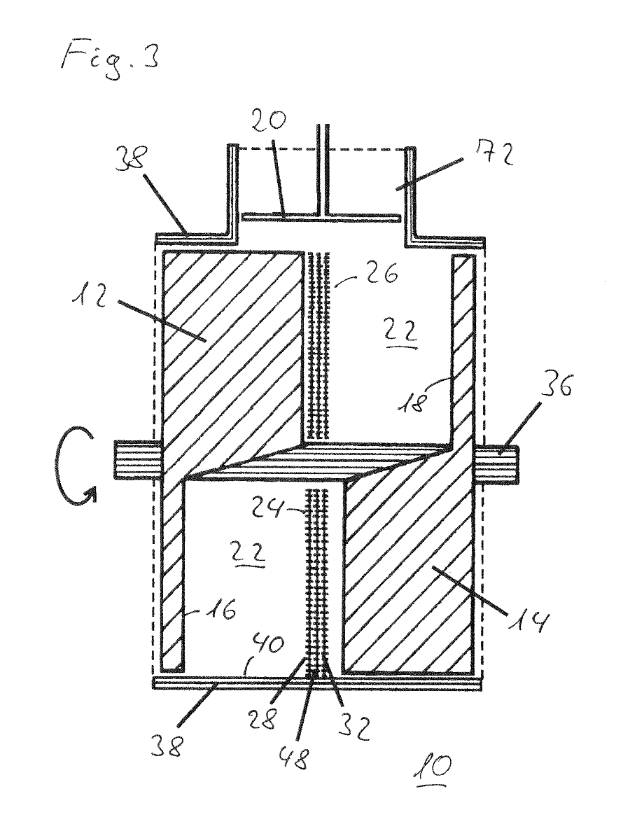

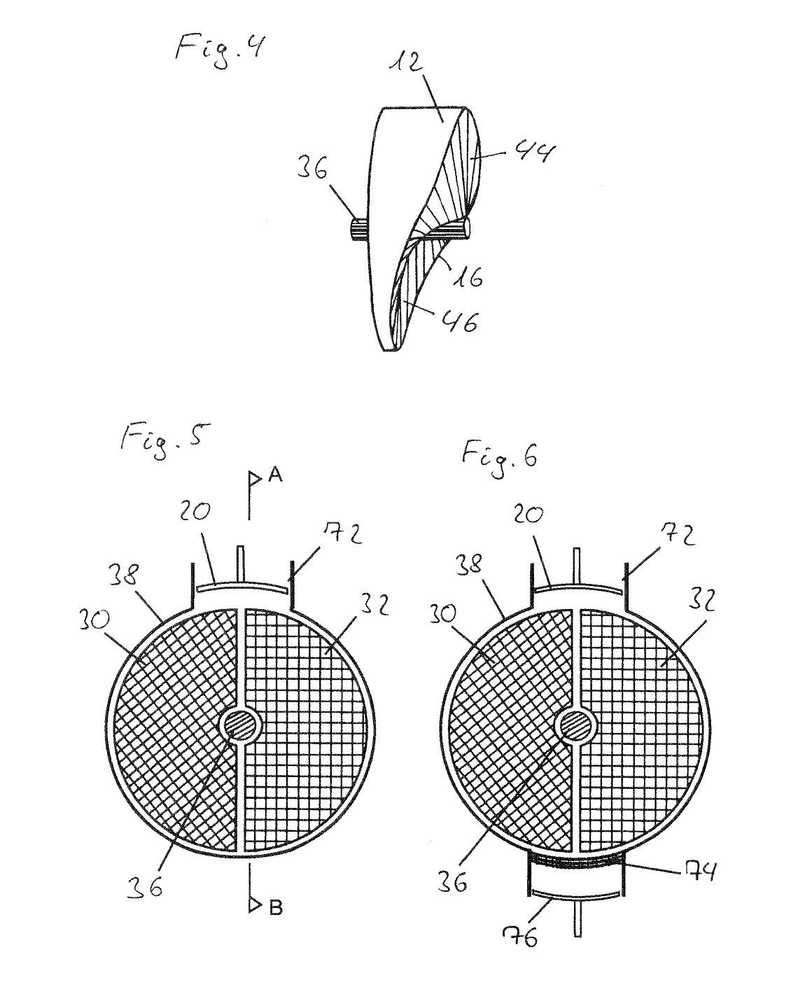

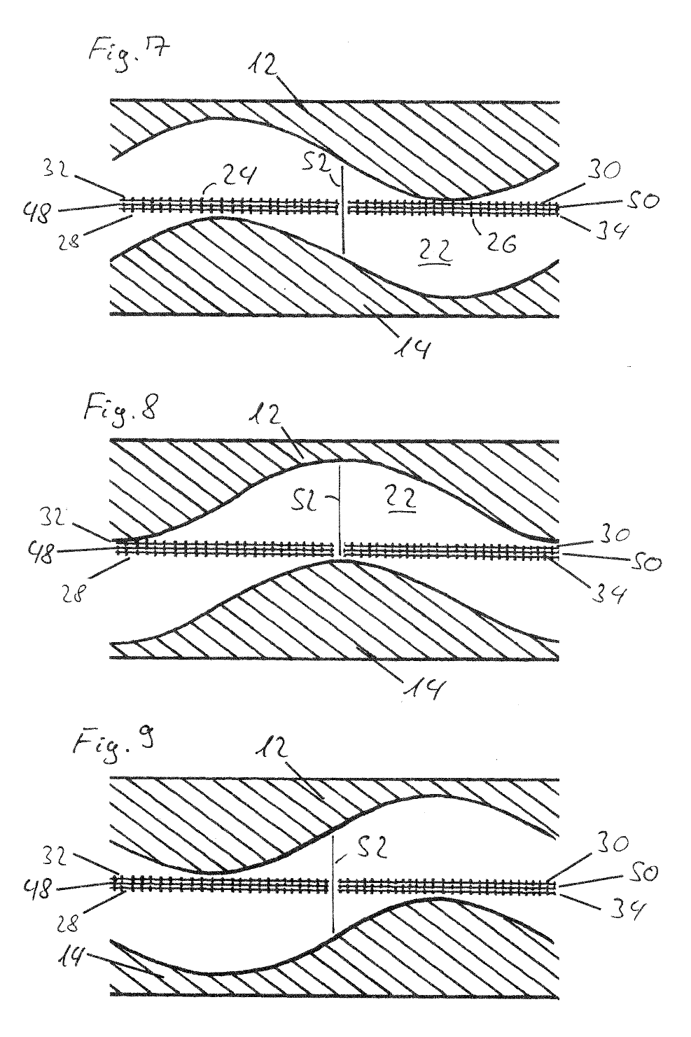

FIG. 3 shows a sectional drawing through a housing 38, displacing pistons 12, 14, heat exchanger arrangements 24, 26 and an adiabatic working piston 20. The housing 38 is shaped like a cylinder having a nozzle along the axis. The displacing pistons 12, 14 are arranged at the face sides of the cylinder. There are exactly two heat exchanger arrangements 24, 26. Both heat exchanger arrangements 24, 26 are arranged in the symmetry area perpendicular to the axis 36 of the cylinder. In particular, the axis 36 may be an axial axis. The heat exchanger arrangements 24, 26 are separated by a gap to prevent heat losses due to the heat conduction. Each heat exchanger arrangement 24, 26 comprises a sector of about 180° in the azimuthal direction. A heat exchanger arrangement 24, 26 can comprise a heat source 28, a regenerator 48, and a heat sink 32. The first heat exchanger arrangement 24 has its heat source 28 on the side of the first displacing piston 12, and the second heat exchanger arrangement 26 has its heat source 30 on the side of the second displacing piston 14. The axis 36 of the displacing pistons 12, 14 coincides with the geometrical axis of the housing 38, such that the displacing pistons 12, 14 rotate azimuthally with respect to the housing 38. It is appropriate that both displacing pistons 12, 14 are mounted on the same axis 36 or are produced in one piece because both displacing pistons 12, 14 rotate with exactly identical frequencies. Each of the displacing pistons 12, 14 comprises a convex and a concave surface area, wherein the height of the convex and the depth of the concave regions correspond almost to a harmonic function of the azimuthal angle. The maximum height of the convex region is chosen, such that the displacing pistons 12, 14 almost touch or come near the heat exchanger arrangements 24, 26. The minimum distance between the displacing pistons 12, 14 and the heat exchanger arrangements 24, 26 may be less than one percent of the distance between the displacing pistons 12, 14. The working piston 20 is arranged at the connecting piece 72 in the sidewall of the housing 38. The connecting piece 72 is connected to the working space 22 via a recess in the wall housing 40. The displacing pistons 12, 14 provide a cylindrical piston skirt along the sidewall of the housing 38, wherein the piston skirt prevents working gas leaking out of the housing 38.

FIG. 4 is a perspective drawing of the shape of a displacing piston 12. The surface 16 of the described first displacing piston 12 provides a convex area 44 and a concave area 46.

FIGS. 5 and 6 show a sectional drawing through FIG. 3 in the plane of the heat exchanger arrangements. On the other hand, FIG. 3 is a sectional drawing along A-B through FIG. 5. The section A-B is shifted a little bit aside with respect to the cylinder axis.

Otherwise, FIG. 3 would not show any heat exchanger arrangement due to the gap between the two heat exchanger arrangements. FIG. 5 shows an embodiment having only an adiabatic working piston 20, and FIG. 6 shows an embodiment having an adiabatic working piston 20 and a further isobar working piston 76 that is arranged at the housing 38 with an azimuthal position differing from the azimuthal position of the adiabatic working piston 20. In particular, FIG. 6 shows how a further heat exchanger arrangement 74 is mounted at the junction between the housing 38 and the connecting piece of the further isobar working piston 76. The further heat exchanger arrangement 74 is mounted, such that only warm gas flows in the connecting piece and only cold gas flows back to the housing 38.

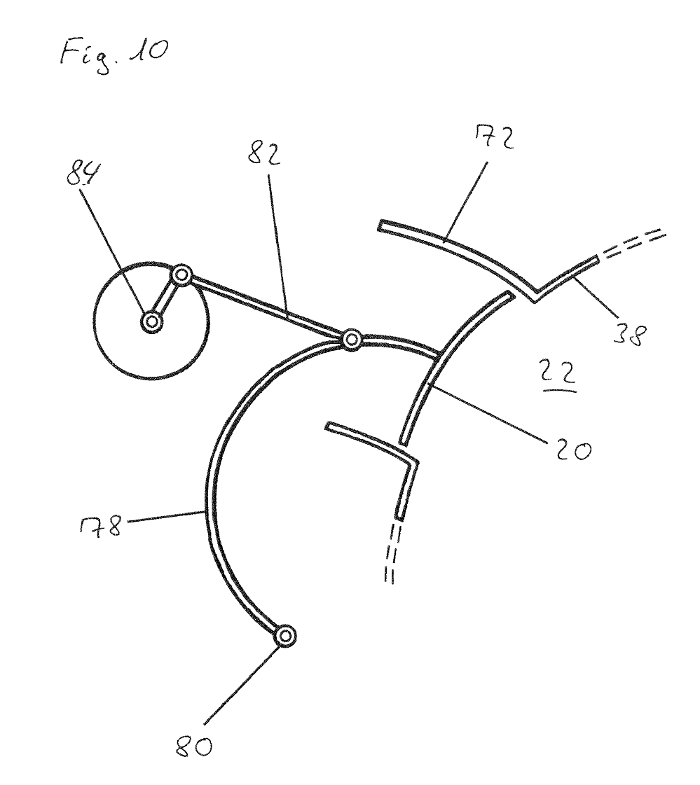

FIGS. 7, 8 and 9 show a schematic representation of the sinusoidal curve of the surfaces 16, 18 of the displacing pistons 12, 14 and their motion with respect to stationary heat exchanger arrangements 24, 26. This representation is a cylindrical projection in the plane of the drawing. The picture is generated by unrolling the cylindrical projection in the plane of the drawing. FIG. 7 shows the displacing pistons 12, 14 when almost all of the working gas is on the side of the heat sinks 32, 34. FIG. 9 shows the displacing pistons 12, 14 when almost all of the working gas is on the side of the heat sources 28, 30. FIG. 8 shows the displacing pistons 12, 14 in a position that corresponds to a moment between the situations illustrated in FIG. 7 and FIG. 9. The displacing pistons 12, 14 move with identical speed relative to the heat exchanger arrangements 24, 26 that comprise the heat sources 28, 30 and the heat sinks 28, 30. The displacing pistons 14, 16 move from the left to the right. A regenerator 48, 50 is arranged between the heat sources 28, 30 and the heat sinks 32, 34 to separate them. Furthermore, the panel 52 braking the working gas is pictured. The panel 52 is reciprocating between the displacing pistons 12, 14.

FIG. 10 shows a working piston 20 in connection with a piston rod 78, a connecting rod 82 and a crankshaft 84. The piston rod 78 is swiveled back and forth around a swiveling axis 80 that absorbs the transverse forces of the connecting rod 82. As can be seen in FIG. 10, the connecting piece 72 containing the moving working piston 20 may have a curved shape due to the swiveling motion of the piston rod 78.

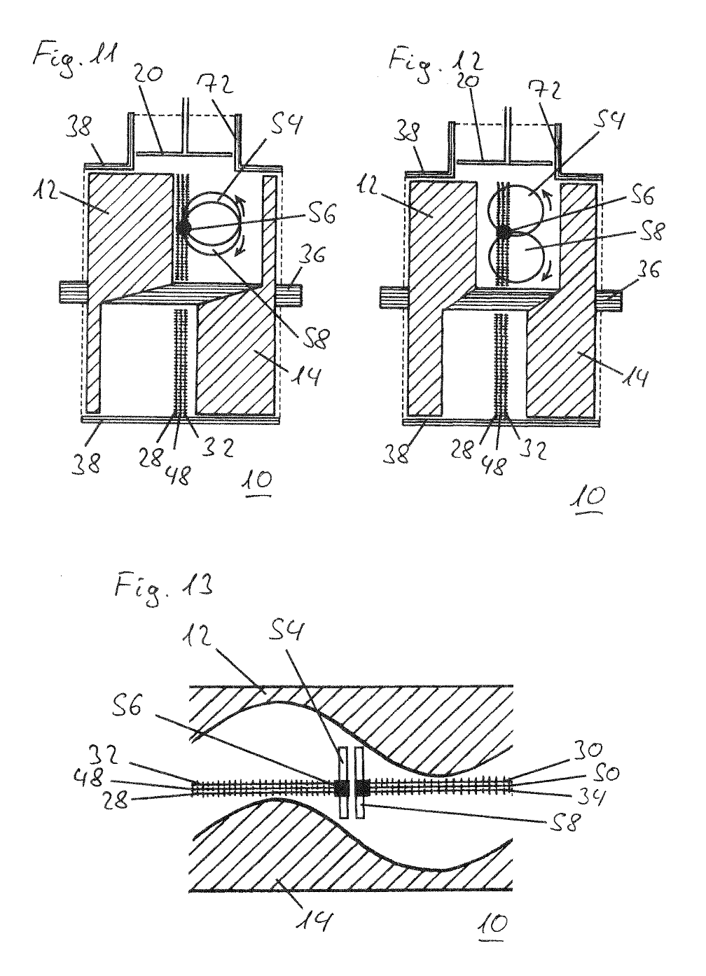

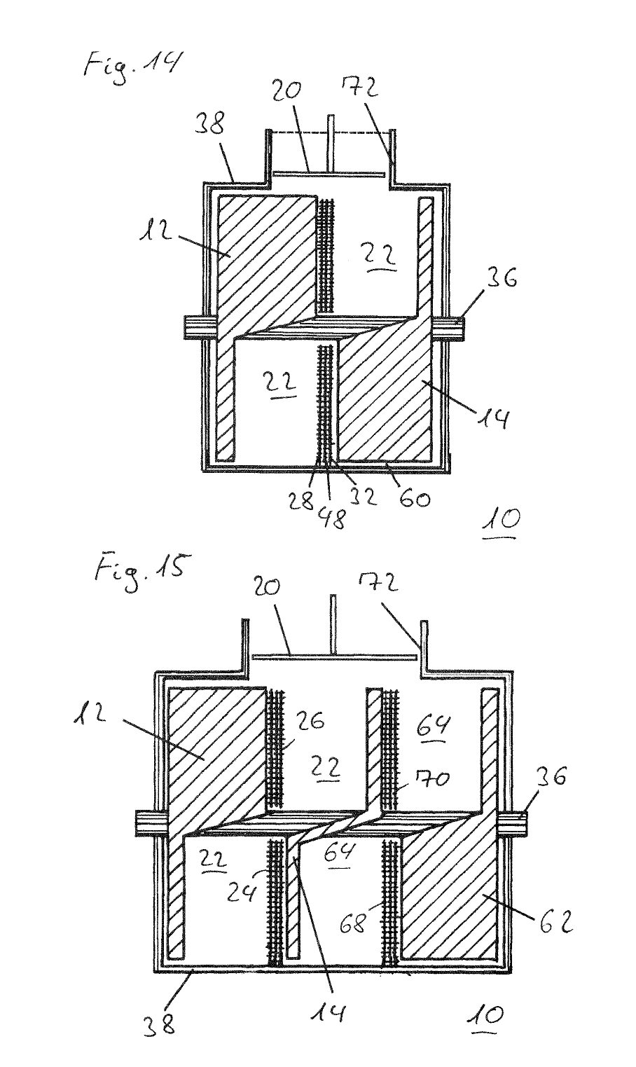

FIG. 11 shows a top view of rotating panels 54, 58 that act as braking panels. Their rotation frequency is identical with the frequency of the displacing pistons 12, 14. For example, the panels 54, 58 can be driven from the axis 36 by a thin driving rod with toothed wheels. The planes of rotation of the two panels 54, 58 are arranged slightly shifted with respect to each other, such that the panels 54, 58 can pass each other in their opposite motion around a mounting axis 56. FIG. 12 shows the positions of the panels 54, 58 later during the rotation period. FIG. 13 shows the positions of the panels 54, 58 in accordance to FIG. 7, such that it is clear how the panels 54, 58 prevent the working gas to circulate together with the displacing pistons 12, 14. It applies for the panels 54, 58 that they are shaped, such that they block an area of the cross section of the working space as large as possible under the condition that they never touch the displacing pistons during their motion. It can be seen from FIGS. 11 and 12 that the blocking of the cross section of the working space is at maximum when the distance of the heat exchanger arrangements 24, 26 to the two displacing pistons 12, 14 measured in the plane of the panels 54, 58 is equal. This is ideal because the surfaces 16, 18 of the displacing pistons 12, 14 at this time and at this point rotatingly pass the working gas with their steepest angle and thus create the largest flow resistance in the azimuthal direction.

FIG. 14 shows a further embodiment of a heat engine. Here, the gap between the displacing pistons 12, 14 and the housing 38 is larger when compared with the embodiment according to FIG. 3. However, the volume of the working gas that is in the gas gaps 60 and behind the displacing pistons 12, 14 is negligible compared with the volume of the working space 22.

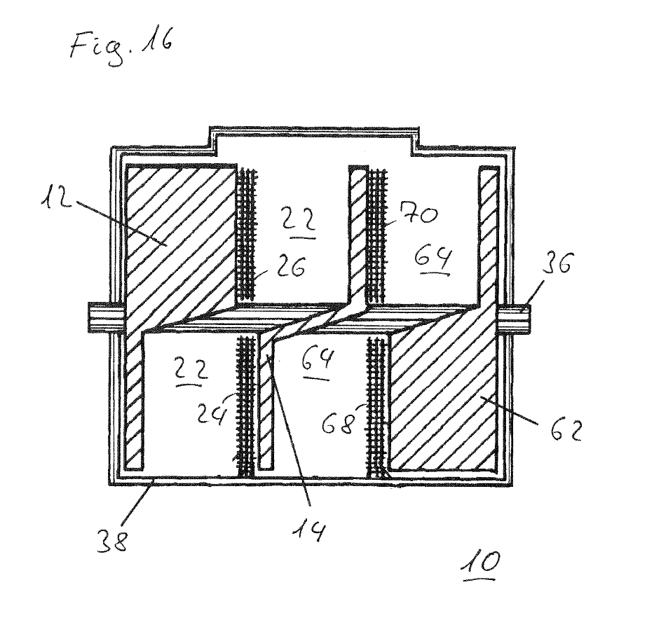

FIG. 15 shows a further embodiment of the heat engine. In this embodiment the second displacing piston 14 has no piston skirt or is not shaped as a closed body.

FIG. 16 shoes a further embodiment of a heat engine.

The described heat engines have many advantages with respect to the state of the art. A larger heat transfer compared with conventional heat engines having flat heat exchanger surfaces can be reached in relation to the volume of the engine because working gas flows through the heat exchanger arrangements in the described heat exchanger engines.

The flow losses in the described heat engine are substantially lower than with conventional engines, because the heat exchanger arrangements are arranged between both displacing pistons, such that the working gas does not change the direction of flow and has not to flow through a substantial restriction of the flow channel on its way from one side of the heat exchanger arrangement to the other side. This advantage is especially important at low temperature differences between heat source and heat sink because in this case a large gas flow rate is necessary and the mechanical output power of the engine is low as compared to the absorbed amount of heat. The flow losses due to the friction of the working gas at the surfaces of the displacing pistons can be minimized by providing further working spaces and by reducing the rotation frequency.

The engine can operate in a large range of rotating speed and in a large range of temperature differences with an almost constant thermal efficiency rate because the functional principle of the described heat engines is independent from the temperature difference between heat source and heat sink over a large region and independent from the operating speed. The mechanical output power can be adapted very easily to the available heat by changing the rotating speed. The temperature differences between heat source and heat sink determines the pressure amplitude and thus the mechanical energy per rotation at a given compression factor.

The heat engine according to the present invention has a high engine smoothness even for large sized embodiments, such that the components have to bear only small loads and experience only little wear because the displacing pistons execute a continuous rotating motion. Consequently, the components of the heat engine can be constructed in a light-weight design and with low costs.

Wear and mechanical friction losses can be minimized because the seals can be constructed as narrow gap rings. A further advantage is based on the fact that the average pressure level of the working gas corresponds to the level of the ambient pressure, if the seals are gap rings. In this case a working piston provides effective work during the expansion work cycle as well as during the compression work cycle. Thus, a fly wheel may be dispensable.

The heat engine according to the present invention can be economically used to generate mechanical output power from heat sources on a low temperature level that are present in many cases. Such heat sources may be, for example, thermal solar energy sources from conventional non-focusing solar collectors, waste heat from engines or warm desert sand during the cold night. Due to the low investment costs and despite of the low Carnot efficiency factor for heat sources having a low temperature level, factories for generating mechanical energy from waste heat that use a heat engine according to the present invention may operate more economically than, for example, conventional factories using organic Rankine cycles that typically feature a larger efficiency factor but in connection with slightly larger investment costs. The overall investment costs per electrical unit size for factories having a heat engine according to the present invention may be smaller than for a conventional photovoltaic system if the heat source is a thermal solar system with a simple layout as it is usually used, for example, for heating a swimming pool.

Finally, it is suggested to use a thermal solar system during winter to generate heat on a useful temperature level via the Vuilleumier heat pump according to FIG. 16 to increase the seasonal performance factor significantly.

The features of the invention disclosed in the above description, the drawings as well as in the claims may be important for the realisation of the invention individually or in any combination.

### LIST OF REFERENCE NUMERALS

10 heat engine
12 first displacing piston
14 second displacing piston
16 surface
18 surface
20 working piston
22 working space
24 heat exchanger arrangement
26 heat exchanger arrangement
28 heat source
30 heat source
32 heat sink
34 heat sink
36 axis
38 housing
40 housing wall
44 convex area
46 concave area
48 regenerator
50 regenerator
52 panel
54 panel
56 mounting axis
58 further panel
60 gas-filled gap
62 third displacing panel
64 further working space
66 surface
68 heat exchanger arrangement
70 heat exchanger arrangement
72 connecting piece
74 further heat exchanger arrangement
76 further working piston
78 piston rod
80 swiveling axis
82 connecting rod
84 crankshaft

1-15. (canceled)

16. A heat engine, comprising:
a first displacing piston; and
a second displacing piston, wherein:
a surface of the first displacing piston and a surface of the second displacing piston that face each other limit a working space that is filled with a working gas,
two heat exchanger arrangements are arranged in the working space between the first displacing piston and the second displacing piston, each heat exchanger arrangement comprising a heat source and a heat sink, the working gas flowing through or circulating around each of the two heat exchanger arrangements,
at least one of the first displacing piston, the second displacing piston, and the heat exchanger arrangements are rotatably mounted with respect to an axis, and
a circular motion of the working gas around the axis relative to the heat exchanger arrangements is counteracted.

17. The heat engine according to claim 16, wherein:
the surface of the first displacing piston that limits the working space is curved convexly, and the surface of the second displacing piston that limits the working space is curved concavely.

18. The heat engine according to claim 17, wherein:
the surface of the first displacing piston and the surface of the second displacing piston that limit the working space are surfaces of cylinder barrels substantially, wherein the symmetry axes of the cylinders do not coincide with the axis.

19. The heat engine according to claim 16, wherein:
the surface of the first displacing piston and the surface of the second displacing piston that limit the working space are surfaces of cylinder barrels substantially, wherein the symmetry axes of the cylinders do not coincide with the axis.

20. The heat engine according to claim 16, wherein:
the first displacing piston and the second displacing piston execute a rotating motion with identical frequencies within a housing,
wherein a housing wall in combination with the surface of the first displacing piston and the surface of the second displacing piston that face each other limit the working space,
wherein the surfaces of the first displacing piston and the second displacing piston, respectively, that limit the working space have convex and concave areas, wherein the convex areas of the first displacing piston correspond to or face the concave areas of the second displacing piston, wherein the concave areas of the first displacing piston correspond to or face the convex areas of the second displacing piston, and
wherein the spatial arrangement and the number of convex and concave areas of the first displacing piston and second displacing piston correspond to the spatial arrangement and the number of the heat exchanger arrangements, wherein a heat source corresponding to each convex area of a displacing piston exists that faces this displacing piston, and wherein a heat sink corresponding to each concave area of the same displacing piston exists that faces this displacing piston.

21. The heat engine according to claim 20, wherein the first displacing piston and the second displacing piston are produced in one piece.

22. The heat engine according to claim 16, wherein the first displacing piston and the second displacing piston are produced in one piece.

23. The heat engine according to claim 16, wherein the heat exchanger arrangements comprise a regenerator.

24. The heat engine according to claim 16, wherein one of a blower and fan counteracts against the circular motion of the working gas around the axis.

25. The heat engine according to claim 16, wherein a panel that is movable in a reciprocating fashion in a plane transverse to the displacement pistons or transverse to the heat exchanger arrangements counteracts against the circular motion of the working gas with around the axis.

26. The heat engine according to claim 16, wherein a panel that rotates around a mounting axis counteracts against the circular motion of the working gas with around the axis.

27. The heat engine according to claim 26, wherein a further panel that rotates with respect to the panel in the opposite direction around the mounting axis counteracts against the circular motion of the working gas around the axis.

28. The heat engine according to claim 16, wherein the heat exchanger arrangements that rotate around the axis synchronically with the working gas counteract against the circular motion of the working gas around the axis.

29. The heat engine according to claim 20, wherein:
the first displacing piston and the second displacing piston are completely arranged in the housing;
wherein a gas-filled gap is provided between the borders of the first and/or second displacing piston and the housing, and between the back sides of the first and/or second displacing piston and the housing; and
wherein the gas-filled gap provides a pressure equalization between the working space and the back sides of the first and/or second displacing piston.

30. The heat engine according to claim 16, further comprising:
a further working space that is limited by the second displacing piston and a third displacing piston, wherein the working space and the further working space are orientated back-to-back such that the back side of the second displacing piston forms a surface that limits the further working space; and
wherein the third displacing piston and/or heat exchanger arrangements that are arranged in the further working space are rotatably mounted with respect to the axis.

31. The heat engine according to claim 30, wherein:
a gas exchange is possible between the working space and the further working space; and
wherein the heat exchanger arrangements are arranged such that the working space works in a heat engine mode and the further working space works in a heat pump mode when the displacing pistons rotate synchronically.

32. The heat engine according to claim 31, wherein the working space and the further working space have different sizes.

33. The heat engine according to claim 30, wherein the working space and the further working space have different sizes.
